(19) United States
(12) Patent Application Publication
(10) Pub. No.: US 2016/0098129 A1
(43) Pub. Date: Apr. 7, 2016

(54) TOUCH PANEL AND DISPLAY TOUCH PANEL

(71) Applicant: InnoLux Corporation, Miao-Li County (TW)

(72) Inventors: Li-Wei SUNG, Miao-Li County (TW); Yu-Chien KAO, Miao-Li County (TW); Neng-Hsien WANG, Miao-Li County (TW); Tsan-Chu LU, Miao-Li County (TW); Chu-Hung TSAI, Miao-Li County (TW)

(21) Appl. No.: 14/862,225

(22) Filed: Sep. 23, 2015

(30) Foreign Application Priority Data
Oct. 3, 2014 (TW) 103134574

(51) Int. Cl. G06F 3/045; G06F 3/041

(52) U.S. Cl. CPC G06F 3/045; G06F 3/0416; G06F 2203/04112

(57) ABSTRACT

A touch panel and a display touch panel comprising the same are disclosed. The touch panel includes a sensing electrode containing a plurality of hexagonal units disposed beside each other; wherein one of the hexagonal units comprises a plurality of interconnect lines and these interconnect lines form a plurality of polygons in one of the hexagonal units, wherein each of the polygons includes three or more interior angles and one of the interior angles of one polygon is different from one of the interior angles of another polygon.

### CROSS REFERENCE TO RELATED APPLICATION

This application claims the benefits of the Taiwan Patent Application Serial Number 103134574, filed on Oct. 3, 2014, the subject matter of which is incorporated herein by reference.

### BACKGROUND OF THE INVENTION

1. Field of the Invention

The present disclosure relates to a touch panel, and especially to a display touch panel with low resistance and with reduced Moire effect.

2. Description of Related Art

As the display technology advances, all the display devices are now being developed toward smaller sizes, thinner shapes, and lighter weights. Thus, the mainstream display devices in the current market have evolved from the previous cathode ray tubes to LCD, OLED, LED displays. These displays, in particular, can be applied in a variety of fields. For example, in daily life, these displays are usually used as the display panels for the display devices of mobile phones, laptop computers, camcorders, cameras, music players, mobile navigation devices, automotive monitors and televisions. Since the current trend of development is toward user-friendly and simplistic operation modes, display devices with touch panels are now being widely used in life.

### SUMMARY OF THE INVENTION

The present disclosure provides a touch panel, including: a first substrate; a sensing electrode disposed on the first substrate, comprising a plurality of hexagonal units disposed beside each other; wherein one of the hexagonal units comprises a plurality of interconnect lines and these interconnect lines form a plurality of polygons in one of the hexagonal units; wherein each of the polygons includes three or more interior angles and one of the interior angles of one polygon is different from one of the interior angles of another polygon.

The present disclosure also provides a display touch panel, including: a first substrate; a second substrate; a display medium layer disposed between the first substrate and the second substrate; a sensing electrode disposed on the first substrate, and the sensing electrode comprising a plurality of hexagonal units disposed beside each other; a plurality of pixels disposed between the first substrate and the second substrate, wherein one of the hexagonal units comprises a plurality of interconnect lines and the interconnect lines form a plurality of polygons in the one of the hexagonal units, and wherein each of the polygons includes three or more interior angles and one of the interior angles of one polygon is different from one of the interior angles of another polygon.

In the touch panel of the present disclosure, the pattern of the sensing electrode is different from the conventional designs. Hence, the Moire effect caused by the similarity in the dimensions of the metal mesh pattern and the pixels of the display panel can be avoided. In addition, the pattern of the sensing electrode made by a low-resistance metal material has a high transmission. As a result, these sensing electrodes will be suitable for the manufacturing of small-size, medium-size and large-size touch panels.

### BRIEF DESCRIPTION OF THE DRAWINGS

FIG. 1 is a schematic diagram of the touch panel of a preferred embodiment of the present disclosure.

FIG. 2 is an enlarged view of a partial part (boxed by dashed lines) of the touch panel in FIG. 1.

FIG. 3A is a schematic diagram of the hexagonal unit of a preferred embodiment of the present disclosure.

FIG. 3B is a schematic diagram of the hexagonal unit of a preferred embodiment of the present disclosure.

FIG. 3C is a schematic diagram of the hexagonal unit of a preferred embodiment of the present disclosure.

FIG. 4 is a schematic diagram of the display touch panel of a preferred embodiment of the present disclosure.

### DETAILED DESCRIPTION OF THE PREFERRED EMBODIMENT

Hereinafter, exemplary embodiments of the present disclosure will be described in detail. However, the present disclosure is not limited to the embodiments disclosed below, but can be implemented in various forms. The following embodiments are described in order to enable those skilled in the art to practice the present disclosure and to appreciate that various modifications, additions, and substitutions are possible.

### Embodiment

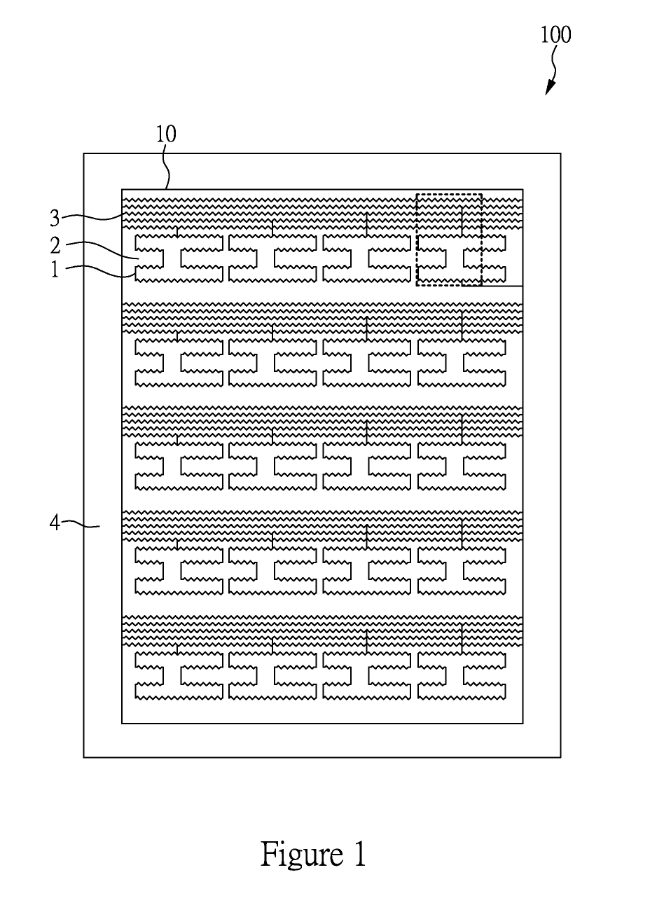

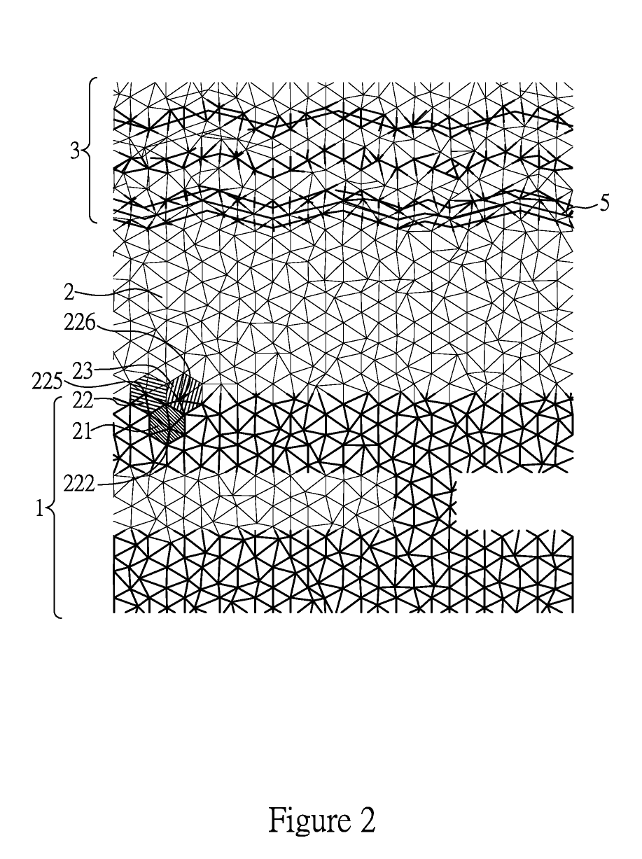

FIG. 1 is a schematic diagram of the touch panel of a preferred embodiment of the present disclosure. The touch panel 100 of this embodiment comprises a substrate (figure not shown, the substrate hereinafter may be a glass substrate, a plastic substrate, a silicon substrate, a ceramic substrate, a flexible substrate or the like) and a sensing electrode 10 disposed thereon, wherein the sensing electrode 10 comprises a signal transducing electrode 1, a signal receiving electrode 2, and traces 3. The sensing electrode 10 is disposed on a substrate and the periphery of the substrate includes a decorative portion 4. An enlarged view of a partial part (boxed by dashed lines) of the touch panel in FIG. 1 is shown in FIG. 2.

As shown in FIG. 2, the sensing electrode 10 of the present embodiment is a metal mesh layer, which comprises a plurality of hexagonal units 21, 22, 23 disposed beside each other. The intersection points 222, 225, 226 of the interconnect lines in each of the respective hexagonal units 21, 22, 23 are located at different positions in one of the hexagonal units especially for any two hexagonal units that are adjacent to each other. This avoids a regular arrangement that may degrade the display quality. In the regions of the signal transducing electrode 1 and the signal receiving electrode 2, the pattern of the metal mesh layer corresponding to the pattern of the pixels of the display panel preferably includes a disconnection design (not shown). This design can avoid the Moire effect that may degrade the display quality. It is worth to note that the metal mesh made by the hexagonal units randomly disposed beside each other requires less complicated experimental procedures. The optical property and the conduction resistance of the sensing electrode can also be controlled more easily. If necessary, in addition to the hexagonal units 21, 22, 23, the signal transducing electrode 1 can also possess a plurality of connection lines 5 crossing through the hexagonal units (as shown in FIG. 2, in addition to the marked connection lines 5, other connection lines can also be presented) in order to achieve better display quality.

In the present disclosure, the material of the hexagonal units is not particularly limited but preferably a metal or a conductor with low resistance. This material can be aluminum, silver, copper, chromium, titanium, molybdenum, a combination thereof, or a transparent conductor. In this embodiment, aluminum is used to prepare the hexagonal units. The metal lines of the metal mesh layer have a width range from 2.5 μm to 3.5 μm. If necessary, a black oxide layer may be coated on the metal mesh layer to reduce the reflected light of the metal. The metal mesh layer may be produced by any conventional technology known in the art, such as a printing process or a photolithography process. To obtain a metal mesh layer with finer line width, the photolithography process is preferred due to its much easier control of the desired line width.

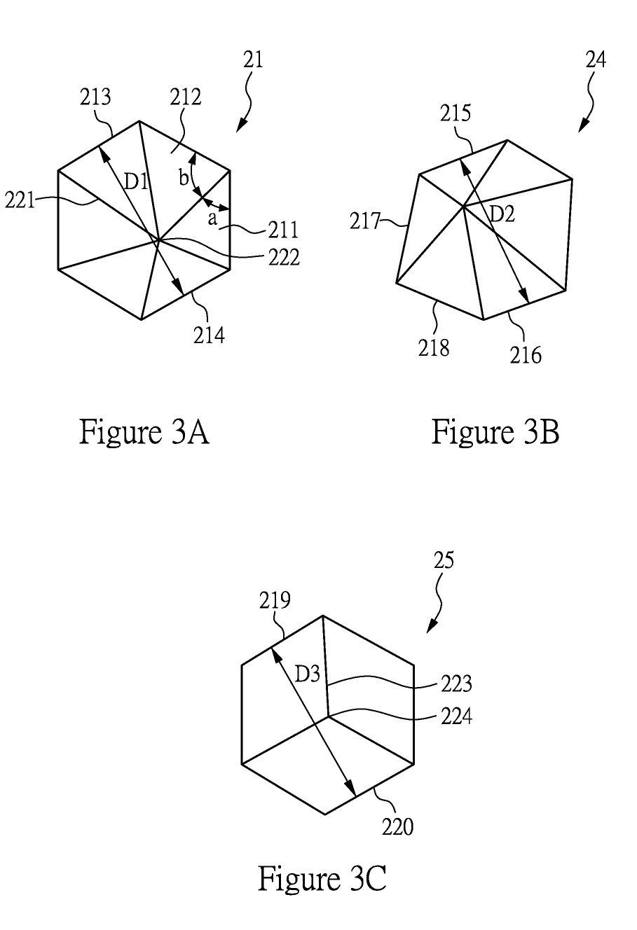

An enlarged view of the hexagonal unit 21 is shown in FIG. 3A. The hexagonal unit 21 comprises a plurality of interconnect lines 221. The interconnect lines form a plurality of polygons 211 in the hexagonal unit 21.

Each of the polygons 211 includes three or more interior angles. One of the interior angles a of one polygon 211 is different from one of the interior angles b of another polygon 212. In other words, in the polygons 211 and 212, the polygon 211 may have two interior angles a the same as two interior angles b of the polygon 212; or the polygon 211 may have only one interior angle a the same as one interior angle b of the polygon 212; or the three interior angles a of the polygon 211 are all different from the three interior angles b of the polygon 212.

The hexagonal unit 21 may be a regular or an irregular hexagonal unit. The exemplary configuration of the hexagonal unit 21 shown in FIG. 3A is a regular hexagonal unit, which is a regular hexagon. A distance D1 exists in between the first side 213 and the second side 214 of the hexagonal unit 21. This distance D1 is not particularly limited and may be 50 μm to 200 μm, preferably 100 μm to 200 μm, more preferably 150 pm to 200 μm, and may also be 200 μm or more. The first side 213 of the hexagonal unit 21 is parallel to the second side 214 of the hexagonal unit 21.

Alternatively, if the hexagonal unit 21 is an irregular hexagonal unit, its configuration may be that of the hexagonal unit 24 as shown in FIG. 3B. A distance D2 exists in between the first side 215 and the second side 216 of the hexagonal unit 24. This distance D2 is not particularly limited and may be 50 μm to 200 μm, preferably 100 μm to 200 μm, more preferably 150 μm to 200 μm, and may also be 200 μm or more. In this hexagonal unit 24, a third side 217 connects the first side 215 and a fourth side 218 connects the second side 216; wherein the third side is nonparallel to the fourth side.

The transmittances of the sensing electrode 10 of the present embodiment when it comprises a plurality of the hexagonal units 21 shown in FIG. 3A are as follows: when the distance D1 between the first side 213 and the second side 214 of the hexagonal unit 21 is 50 μm, the transmittance is 65.62%; when distance D1 between the first side 213 and the second side 214 of the hexagonal unit 21 is 100 μm, the transmittance is 81.38%; when the distance D1 between the first side 213 and the second side 214 of the hexagonal unit 21 is 150 μm, the transmittance is 87.06%; and when the distance D1 between the first side 213 and the second side 214 of the hexagonal unit 21 is 200 μm, the transmittance is 90.06%. Accordingly, the sensing electrode 10 has a better transmittance when the distance D1 between the first side 213 and the second side 214 of the hexagonal unit 21 is from 150 μm to 200 μm.

The hexagonal unit 21 shown in FIG. 3A comprises 6 interconnect lines 221 forming 6 polygons. The interconnect lines 221 connect at one intersection point 222 in the hexagonal unit 21. Each of the polygons and its adjacent polygons commonly share an interconnect line. Each of the polygons is triangular. However, the present disclosure is not limited thereto. The hexagonal unit 25 shown in FIG. 3C may comprise 3 interconnect lines 223 forming 3 polygons. The interconnect lines 223 only have one intersection point 224 in the hexagonal unit 25. Each of the polygons and its adjacent polygons commonly share an interconnect line. Each of the polygons is tetragonal. As such, the hexagonal unit of the present disclosure may comprise a plurality of interconnect lines and a plurality of polygons. The polygons may be triangular, tetragonal, pentagonal, hexagonal, heptagonal, octagonal, etc. Accordingly, depending on the actual demands of those with ordinary skills in the art, the hexagonal unit may differ from that of the present disclosure.

The transmittances of the sensing electrode 10 of the present embodiment when it comprises a plurality of the hexagonal units 25 shown in FIG. 3C are as follows: when the distance D3 between the first side 219 and the second side 220 of the hexagonal unit 25 is 50 μm, the transmittance is 76.83%; when the distance D3 between the first side 219 and the second side 220 of the hexagonal unit 25 is 100 μm, the transmittance is 87.38%; when the distance D3 between the first side 219 and the second side 220 of the hexagonal unit 25 is 150 μm, the transmittance is 90.53%; and when the distance D3 between the first side 219 and the second side 220 of the hexagonal unit 25 is 200 μm, the transmittance is 93.34%. Accordingly, the sensing electrode 10 has a better transmittance when the distance D3 between the first side 219 and the second side 220 of the hexagonal unit 25 is from 150 μm to 200 μm. The sensing electrode 10 comprising a plurality of the hexagonal units 25 shown in FIG. 3C with lesser interconnect lines 223 has a better transmittance than the sensing electrode 10 comprising a plurality of the hexagonal units 21 shown in FIG. 3A.

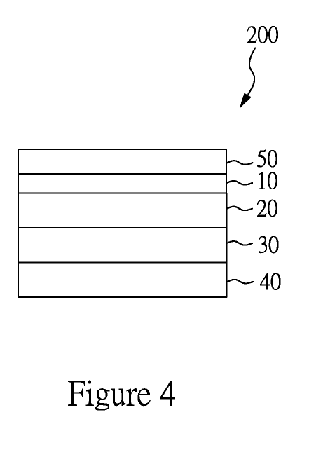

FIG. 4 is a schematic diagram of the display touch panel of a preferred embodiment of the present disclosure. The display touch panel 200 comprises a sensing electrode 10 disposed on a first substrate 20, and a display medium layer 30 disposed between the first substrate 20 and a second substrate 40; and a plurality of pixels (figure not shown) disposed between the first substrate 20 and the second substrate 40. The display touch panel 200 further comprises a protection layer 50 disposed on the sensing electrode 10. In the present disclosure, the pixels can be interpreted as a color unit used to display an image. For example, in a LCD display panel, the color unit is a color filter unit; in an OLED display panel, the color unit is an organic light emitting diode unit; in a LED display panel, the color unit is an inorganic light emitting diode unit.

Hence, the Moire effect caused by the similarity in the dimensions of the metal mesh pattern and the pixels of the display panel can be avoided. The new designed pattern of the sensing electrode coordinated with the pattern of the pixels, thus the Moire effect can be improved effectively.

For purposes of brevity, any description described above is incorporated herein insofar as the same is applicable, and the same description need not be repeated.

For illustrative purposes, in FIG. 4, the actually existing structures in display touch panel 200 are omitted. For instance, the first substrate 20 may be a color filter substrate, the second substrate 40 may be a thin film transistor (TFT) substrate, the display medium layer 30 may be a liquid crystal layer or an electroluminescent diode layer such as organic light emitting diode layer or inorganic light emitting diode layer, and the protection layer 50 may be a cover plate such as a cover glass. However, the present disclosure is not limited thereto. In addition, other functional layers can be included depending on requirements, such as a light shading layer, an optical film, a wire layer, and a protective layer, etc.

In summary, the display touch panel 200 may be applied to any display which has a touch panel, and is not particularly limited. The display touch panel 200 may be a wide variety of touch flat panel displays, for example, a touch liquid crystal display, a touch organic light emitting diode display, a touch inorganic light emitting diode display, or a touch electronic paper display. The practical applications of the display touch panel 200 may be for example, an automobile display, an electromagnetic isolation glass, a cell phone, a solar cell, a portable LCD video game, an LCD panel for home appliances, an instrument display, an organic light-emitting diode display, a LED display, an LCD monitor, a notebook, an LCD television, a plasma display, an electrode for a color filter, or combinations thereof.

Although the present disclosure has been explained in relation to its preferred embodiment, it is to be understood that many other possible modifications and variations can be made without departing from the spirit and scope of the disclosure as hereinafter claimed.

What is claimed is:

1. A touch panel, comprising:
a first substrate;
a sensing electrode disposed on the first substrate, and the sensing electrode comprising a plurality of hexagonal units disposed beside each other;
wherein one of the hexagonal units comprises a plurality of interconnect lines and the interconnect lines form a plurality of polygons in the one of the hexagonal units, and
wherein each of the polygons includes three or more interior angles and one of the interior angles of one polygon is different from one of the interior angles of another polygon.

2. The touch panel of claim 1, wherein the one of the hexagonal units is a regular hexagon.

3. The touch panel of claim 2, wherein the one of the hexagonal units includes a first side and a second side, and wherein a distance between the first side and the second side is 50 μm to 200 μm.

4. The touch panel of claim 3, wherein the first side is parallel to the second side.

5. The touch panel of claim 1, wherein the one of the hexagonal units is an irregular hexagon.

6. The touch panel of claim 5, wherein the one of the hexagonal units includes a first side and a second side, and wherein a distance between the first side and the second side is 50 μm to 200 μm.

7. The touch panel of claim 6, wherein the one of the hexagonal units further includes a third side and a fourth side, and wherein the third side connects the first side and the fourth side connects the second side.

8. The touch panel of claim 7, wherein the third side is nonparallel to the fourth side.

9. The touch panel of claim 1, wherein the one of the hexagonal units includes 3 to 6 polygons.

10. The touch panel of claim 1, wherein each of the polygons is triangular or tetragonal.

11. The touch panel of claim 1, wherein each of the polygons and its adjacent polygon commonly share one of the interconnect lines.

12. The touch panel of claim 1, wherein one of the hexagonal units and its adjacent hexagonal unit commonly share one side of the hexagonal unit.

13. The touch panel of claim 1, wherein the interconnect lines connect at one intersection point in the hexagonal unit.

14. The touch panel of claim 13, wherein two intersection points in adjacent two hexagonal units are located at different relative positions with respect to their corresponding hexagonal units.

15. The touch panel of claim 1, wherein one of the interior angles of one polygon is identical to one of the interior angles of another polygon.

16. The touch panel of claim 1, the sensing electrode further comprises a plurality of connection lines crossing through the hexagonal units.

17. A display touch panel, comprising:
a first substrate;
a second substrate;
a display medium layer disposed between the first substrate and the second substrate;
a sensing electrode disposed on the first substrate, and the sensing electrode comprises a plurality of hexagonal units disposed beside each other; and
a plurality of pixels disposed between the first substrate and the second substrate,
wherein one of the hexagonal units comprises a plurality of interconnect lines and the interconnect lines form a plurality of polygons in the one of the hexagonal units, and
wherein each of the polygons includes three or more interior angles and one of the interior angles of one polygon is different from one of the interior angles of another polygon.

18. The display touch panel of claim 17, wherein the display medium layer is a liquid crystal layer or an electroluminescent diode layer.

19. The display touch panel of claim 17, further comprising:
a protection layer disposed on the sensing electrode.

20. The display touch panel of claim 17, wherein the second substrate is a thin film transistor substrate.
